(19) United States
(12) Patent Application Publication
(10) Pub. No.: US 2019/0171950 A1
(43) Pub. Date: Jun. 6, 2019

(54) METHOD AND SYSTEM FOR AUTO LEARNING, ARTIFICIAL INTELLIGENCE (AI) APPLICATIONS DEVELOPMENT, OPERATIONALIZATION AND EXECUTION

(71) Applicant: Kumar Srivastava, Mountain View, CA (US)

(72) Inventor: Kumar Srivastava, Mountain View, CA (US)

(21) Appl. No.: 16/271,873

(22) Filed: Feb. 10, 2019

(51) Int. Cl. G06N 5/04; G06Q 10/06

(52) U.S. Cl. CPC G06N 5/04; G06Q 10/067

(57) ABSTRACT

Disclosed is a method and a system a method and a system for auto learning, artificial intelligence (AI) applications development, and execution. Various applications or operations may be associated with training environment-agnostic AI models, automated AI app application performance monitoring, fault, quality and performance remediation through prediction of failures or suboptimal performance, privacy and secure AI training and inference mechanism for data and AI model sharing between untrusted parties, and building auto learning applications that can automatically learn and improve.

### FIELD OF THE INVENTION

The present invention relates generally to artificial intelligence (AI), and, more particularly, to a method and a system for auto learning, AI applications development, and execution.

### BACKGROUND

Currently, the process of contract authoring and negotiation is manually performed over tedious document editing, versioning and sharing over physical or digital documents that are error prone due to complex and ad hoc versioning schemes and multiple editing and approval parties. In addition, these contracts need to be inspected and SLAs, policies, regulatory requirements and deadlines and description of promised services have to be extracted and verified against actual delivery to determine adherence to contract. This process is also manual, expensive and prone to errors.

Also, the process of creating machine learning trained models is manual with multiple iterations required to be carried out manually with manually selected training parameters such as the algorithm, the hyper parameter settings and other training infrastructure configuration settings. The process often is tedious and slow and can take too long at the cost of delays in building the best possible models. There are some advances in automation in the software but no current techniques automate the process intelligently. Thus, there is a need for a real-time, automatically scalable AI inference system for custom, training environment-agnostic AI models that enable the prediction of events to entities through the generation of an impact measure between events and entities.

### BRIEF SUMMARY

It is an objective of the present invention to provide a method and a system for auto learning, artificial intelligence (AI) applications development, and execution. In an embodiment, the present invention provides a real-time, automatically horizontally scalable AI inference system for custom, training environment-agnostic AI models. In an embodiment, the present invention further provides automated AI application performance monitoring and fault, quality, and performance remediation through prediction of failures or suboptimal performance In an embodiment, the present invention further provides privacy and secure AI training and inference mechanism for data and AI model sharing between untrusted parties. In an embodiment, the present invention further provides user search driven automated AI model training and operationalization. In an embodiment, the present invention further provides an ability to build auto learning applications that can automatically learn and improve.

In an embodiment, the present invention further enables the determination of the impact of any event on any type of entities. The technique enables entities to be notified and prepared to react to events and their associated impact on the entity. In one embodiment, the impact of market, business and political events can be easily determined for any given entity and the associated set of recommended actions generated including recommendations and insights into how similar events were handled in the past.

In an embodiment, the present invention further enables entities, such as users and organizations, to discover and be notified of interesting and relevant news and information that has potential positive and/or negative implications on the entity. The present invention further enables collaborative authoring, negotiation and approval of contracts between two or parties with controlled visibility, voting and approval. The present invention facilitates automatic extraction of contracted services description, service quality measures, service level agreements, policies, deadlines, regulatory requirements and timelines and stores and executes them automatically to ensure full compliance, measured service quality, billing implications and notifications. The present invention automatically maximize quality of AI based models and maximize throughput of AI training infrastructure. Thus, the present invention enables the automatic generation of the best quality AI trained models in a constantly improving, artificially intelligent driven training mechanism. In addition, the present invention also enables the maximum utilization of capacity of the training environment to ensure that the best models can be trained and identified. These and other features and advantages of the present invention will become apparent from the detailed description below, in light of the accompanying drawings.

### BRIEF DESCRIPTION OF THE ACCOMPANYING DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of various examples. It is expressly understood, however, that the drawings are for the purpose of illustration and description only and are not intended as a definition of the limits of the invention. Embodiments of this invention will now be described by way of example in association with the accompanying drawings in which:

FIG. 1 is a block diagram that illustrates a system environment in which various embodiments of the present invention are practiced;

FIGS. 2 and 3 shows an exemplary block diagram for illustrating auto learning, artificial intelligence (AI) applications development, and execution, in accordance with an embodiment of the present invention;

FIG. 4 shows an exemplary block diagram for illustrating a technique for prediction of events to entities through generation of an impact measure between events and entities, in accordance with an embodiment of the present invention;

FIG. 5 shows an exemplary block diagram for illustrating relevant news and information recommendations to entities, in accordance with an embodiment of the present invention;

FIG. 6 is a block diagram that illustrates a system architecture of a computer system for illustrating auto learning, artificial intelligence (AI) applications development, and execution, in accordance with an embodiment of the present invention; and

FIG. 7 is a block diagram that illustrates an exemplary architecture for illustrating auto learning, artificial intelligence (AI) applications development, and execution, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components, which constitutes methods and systems for auto learning, artificial intelligence (AI) applications development, and execution. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

Techniques consistent with the present invention provide, among other features, methods and systems for auto learning, artificial intelligence (AI) applications development, operationalization, and execution. While various exemplary embodiments of the disclosed systems and methods have been described below, it should be understood that they have been presented for purposes of example only, and not limitations. It is not exhaustive and does not limit the invention to the precise form disclosed. Modifications and variations are possible in light of the above teachings or may be acquired from practicing of the invention, without departing from the breadth or scope.

The present invention will now be described with reference to the accompanying drawings, which should be regarded as merely illustrative without restricting the scope and ambit of the present invention.

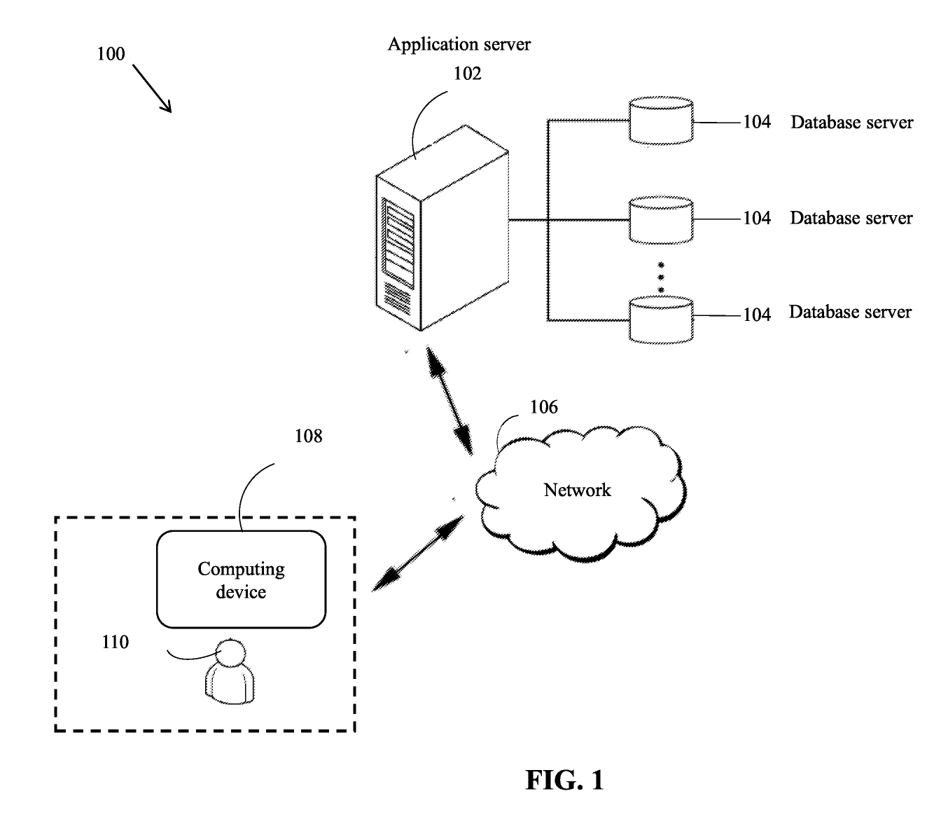

FIG. 1 is a block diagram that illustrates a system environment 100 in which various embodiments of the present invention are practiced. The system environment 100 includes an application server 102, one or more database servers such as a database server 104, and a network 106. The system environment 100 further includes one or more user computing devices associated with one or more users such as a user computing device 108 associated with a user 110. The application server 102 and the user computing device 108 may communicate with each other over a communication network such as the network 106. The application server 102 and the database server 104 may also communicate with each other over the same network 106 or a different network.

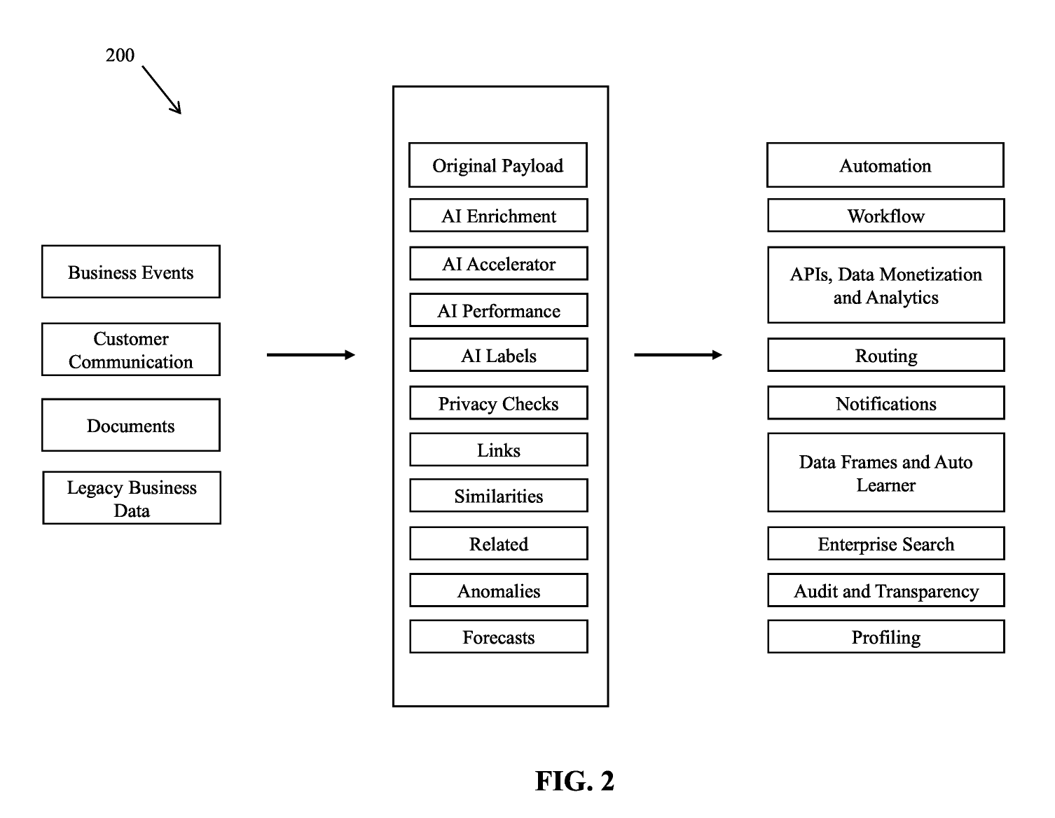

The application server 102 is a computing device, a software framework, or a combination thereof, that may provide a generalized approach to create the application server implementation. Various operations of the application server 102 may be dedicated to execution of procedures, such as, but are not limited to, programs, routines, or scripts stored in one or more memory units for supporting its applied applications and performing defined operations. In an exemplary embodiment, the various applications or operations may be associated with training environment-agnostic AI models, automated AI app application performance monitoring, fault, quality and performance remediation through prediction of failures or suboptimal performance, privacy and secure AI training and inference mechanism for data and AI model sharing between untrusted parties, and building auto learning applications that automatically learn and improve. The application server 102 further enables determination of the impact of any event on any type of entities. The application server 102 further enables entities to be notified and prepared to react to events and their associated impact on the entity. The application server 102 further determines the impact of market, business and political events for any given entity and generates the associated set of recommended actions including recommendations and insights into how similar events were handled in the past. The application server 102 further enables entities, such as users and organizations, to discover and be notified of interesting and relevant news, events and information that has potential positive and/or negative implications on the entity. The application server 102 further enables collaborative authoring, negotiation and approval of contracts between two or parties with controlled visibility, voting and approval. The application server 102 further facilitates automatic extraction of contracted services description, service quality measures, service level agreements, policies, deadlines, regulatory requirements and timelines and stores and executes them automatically to ensure full compliance, measured service quality, billing implications and notifications. The application server 102 further automatically maximizes quality of AI based models and maximize throughput of AI training infrastructure. Various operations of the application server 102 have been described in detail in conjunction with FIGS. 2-6.

Examples of the application server 102 include, but are not limited to, a personal computer, a laptop, or a network of computer systems. The application server 102 may be realized through various web-based technologies such as, but not limited to, a Java web-framework, a .NET framework, a PHP (Hypertext Preprocessor) framework, or any other web-application framework. The application server 102 may operate on one or more operating systems such as Windows, Android, Unix, Ubuntu, Mac OS, or the like.

The database server 104 may include suitable logic, circuitry, interfaces, and/or code, executable by the circuitry that may be configured to perform one or more data management and storage operations such as receiving, storing, processing, and transmitting queries, data, or content. In an embodiment, the database server 104 may be a data management and storage computing device that is communicatively coupled to the application server 102 or the user computing device 108 via the network 106 to perform the one or more operations. In an exemplary embodiment, the database server 104 may be configured to manage and store one or more default AI models, one or more custom AI models, and one or more default business logics, one or more custom business logics. In an exemplary embodiment, the database server 104 may be configured to manage and store input data such as business event data, customer or user communication data, document data, legacy business data, or the like. In an exemplary embodiment, the database server 104 may be configured to manage and store historical data such as historical event detection data, historical event classification data, historical event projection data, historical event impact data, source configuration data, monitoring data, classifier data, impact prediction data, or the like. In an embodiment, the database server 104 may be configured to receive a query from the application server 102 for retrieval of the stored information. Based on the received query, the database server 104 may be configured to communicate the requested information to the application server 102. Examples of the database server 104 may include, but are not limited to, a personal computer, a laptop, or a network of computer systems.

The network 106 may include suitable logic, circuitry, interfaces, and/or code, executable by the circuitry that may be configured to transmit messages and requests between various entities, such as the application server 102, the database server 104, and the user computing device 108. Examples of the network 106 include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the system environment 100 may connect to the network 106 in accordance with various wired and wireless communication protocols, such as Transmission Control Protocol and Internet Protocol (TCP/IP), User Datagram Protocol (UDP), Long Term Evolution (LTE) communication protocols, or any combination thereof.

The user computing device 108 is a computing device that is utilized by the user 110 to perform one or more user operations. The user computing device 108 may include suitable logic, circuitry, interfaces, and/or code, executable by the circuitry, that may be configured to perform the one or more operations. The user computing device 108 may be configured to run a software application or a web application, hosted by the application server 102, that allows the user 110 to perform the one or more operations. For example, the user 110 uses the user computing device 108 to build an abstraction layer for their data and services through a proprietary standardized header format. The user 110 uses the user computing device 108 to generates new intelligent events by combining multiple events using time, location or any other attributes with a considerable overlap and processing these combinations with one or more business logics. The user 110 uses the user computing device 108 to select one or more default AI models available in an AI model library of the database server 104. The user 110 uses the user computing device 108 to upload and configure one or more custom business logics for event processing as logic that is executed when a new event arrives. The user 110 uses the user computing device 108 to upload and configure one or more custom AI models to be executed when events belonging to a certain event category arrive. The output of the one or more default AI models, custom AI models, custom business processing logic is appended on to the event to extend and enrich the event. Performance measures of the execution of the AI models on events including success/failure, time taken and memory consumed are also stamped on to the original event for each AI model. The user 110 uses the user computing device 108 to upload and configure custom predictive routers to be executed based on the output of predictions generated from the previous custom AI model or business logic executions. The user 110 uses the user computing device 108 to configure entity definitions as a set of attributes that define an entity. Entities can be a person, place, or thing. The user 110 uses the user computing device 108 to upload and configure entity event processors that extract attribute values and information from events and update and build entity profiles. The user 110 uses the user computing device 108 to configure data frames that convert incoming events into processed, transformed and enriched dataset definitions including AI-readiness enrichments through application of automated signal detection, automated feature engineering and automated information content estimation. The user 110 uses the user computing device 108 to search over events that are automatically converted through user provided configuration into AI models that are deployed in the path of new incoming events of the same category. The user 110 uses the user computing device 108 to configure offline capabilities such as APIs, analytics, information bots, dashboards for predictive attributes that extend the raw events using the enriched event definition.

In an embodiment, the applications are automatically configured with ticketing capability to automatically and instantly record and process all user interaction with an event to feed directly into new AI model training to produced better event enrichment, extension through default and custom “BYOM” AI models. The applications built on the platform are automatically interconnected and able to communicate with each other by sending and receiving predictive messages over the “AI event bus” provided by the platform. The application server 102 creates an AI model matrix of N×M, where N=number of unique AI models and M=Number of replicas of each AI model. The application server 102 supports both default and custom “BYOM” AI models in this matrix. System admin can add new default models to the matrix and users in a multi-tenanted system can also upload their custom AI models into the matrix. In an embodiment, the ‘M’ or replicas of each AI model is automatically tuned to support the volume of incoming traffic of events or required performance constraints. The application server 102 monitors incoming event traffic and the performance of AI processing of these events to automatically determine and forecast the required number of AI model replicas to satisfy required traffic volume, performance and business requirements. The application server 102 creates the AI model matrix of N×M, where N=number of custom business logic and M=Number of replicas of each custom business logic. The application server 102 supports both default and custom business logic in this matrix. System admin can add new default business logic to the matrix and users in a multi-tenanted system can also upload their custom business logic into the matrix. The ‘M’ or replicas of each business logic is automatically tuned to support the volume of incoming traffic of events or required performance constraints. The application server 102 monitors incoming event traffic and the performance of business logic processing of these events to automatically determine and forecast the required number of business logic replicas to satisfy required traffic volume, performance and business requirements. The application server 102 is also configured to automatically detect the presence of available GPU resources, the presence of GPU “suitable” business logic or AI models, and the availability of GPU resources. The application server 102 also automatically configures the processing to leverage GPUs to ensure all event processing can leverage GPU capabilities as needed.

In an embodiment, the application server 102 is further configured to automatically and instantly update the profile attributes of any and all entities as configured in the system and detected in incoming events. The application server 102 is also able to produce and update more complex attributes by executing processing logic as provided by the system admin for any specific entity or as uploaded by the user 110. The application server 102 is also able to use these profile attributes to predict and forecast the behavior of any of the entities. The application server 102 is also able to automatically segment and/or cluster entity profiles based on their specific attributes and attribute combinations. The application server 102 is also able to predict and forecast the behavior of these profile segment/clusters by combining their data to generate predictions and forecasts. The application server 102 is also able to automatically determine the set of AI models to be applied to any incoming event by inspecting the event's structure, attributes, attribute values, source, payload details and other metadata. The application server 102 is also able to automatically determine the set of actuators or actions to be carried out by inspecting the incoming event's attributes, attribute values, payload structure AND the values of the various AI model predictions, anomaly detection, classifications and timeseries forecasting based insights. The application server 102 also offers the ability for users to model their workflows and processes in an event, decision, action, prediction matrix and can automatically convert it into auto learning AI applications. The application server 102 also enables users to search for a specific set of events from any event category and perform automated feature engineering, signal detection and information content determination. The application server 102 also enables privacy-secure AI training and usage through the use of encrypted data stores for data and model storage and direct, automated data connection between the training system and the storage system. Encryption-Decryption during the process may be realized and implemented using blockchain technologies.

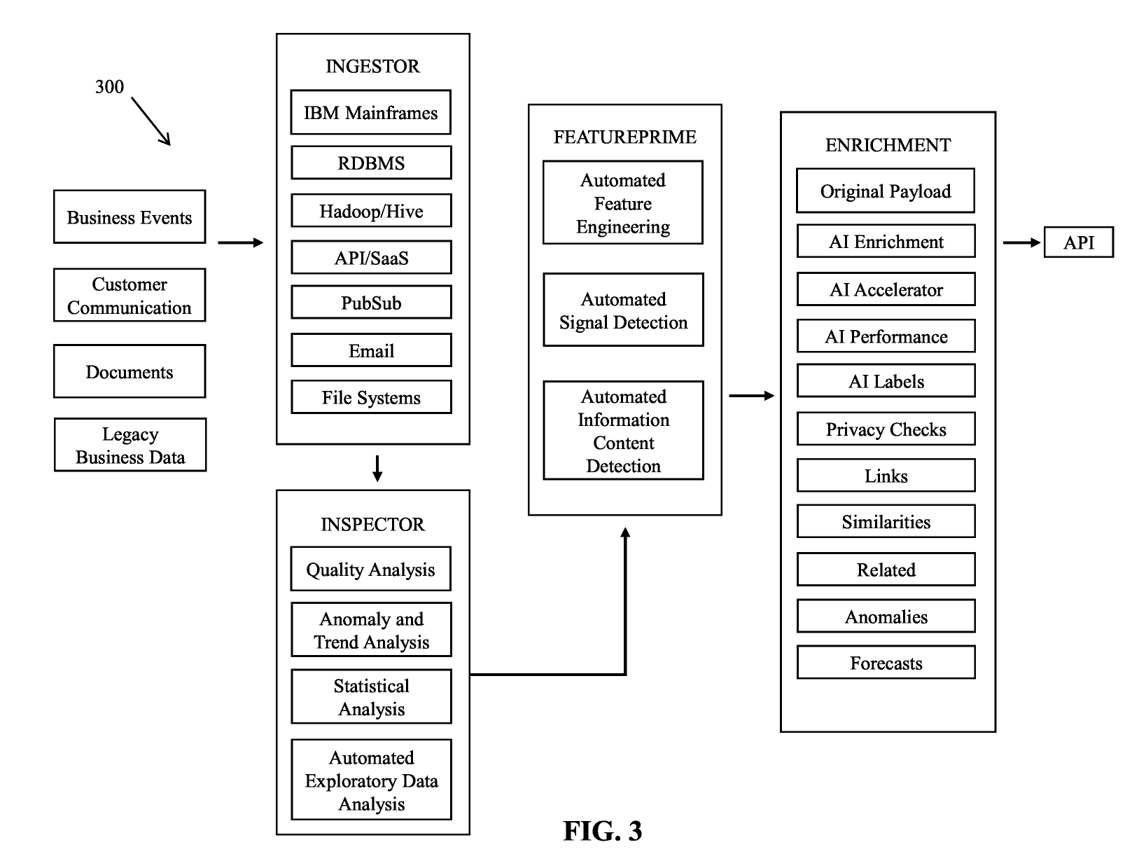

FIGS. 2 and 3 shows exemplary block diagram 200 and 300 for illustrating auto learning, artificial intelligence (AI) applications development, and execution, in accordance with an embodiment of the present invention. The application server 102 processes the incoming events (such as the business events, the customer or user communication, documents, and/or legacy business data) in real time using the one or more default and custom processing logics (such as business logics and AI models) and execute the real-time actions based on output of machine learning and AI predictions. The ingestion system (such as the application server 102, or a specific ingestion component in the application server 102) is able to ingest data from multiple sources through both push and pull mechanisms. The ingestion system ingests data, analyzes the data and extracts interesting events using a combination of rule-based pattern detection and machine learning-based pattern detection. The ingestion system ingests two types of events, for example, the raw events and stores it as an “event category”. In addition, the ingestion system also ingests the “interesting events”, for example, the events that describe or signify a change in the raw events patterns or behavior, or events that are anomalous or different from the other events. These events are ingested as the “interesting” event counterpart of the “event category”. The ingestion system

The LearnCloud platform (such as the application server 102, or a learning platform included with the application server 102) enforces a standard “header” definition for all events. The header describes the event using standardized definition that describes the source, the type, timestamp etc. The actual payload of the event is sent as part of the payload section. The event processor of the application server 102 further analyzes the incoming data using a combination of the one or more default and custom codes and AI models. The output of these custom and default codes and AI models is appended to the event in a new section called the “enrichment”. The users (such as the user 110) are able to upload the one or more custom codes or custom AI models that they have trained in any external system. The application server 102 may also provide the one or more default codes or AI models that perform various types of classifications, analysis, enrichment, transformation and predictions. The application server 102 further automatically detects text attributes in the event payload and applies the following text analysis including automatically generating a knowledge graph, automatically converting the text into a knowledge base of questions and deriving relationships between the event and other events of any event categories including “similar to”, “related to” or “linked to” relationships.

In an embodiment, the application server 102 further uses the metadata layer to determine all AI models and codes that should be executed for any incoming event and analyzes the event against those codes and AI models and appends the output classifications and predictions to the event as part of the “Enrichment” part of the event. The application server 102 analyzes the pattern of incoming events of all event categories and uses the profile of events and distribution of events and event payload attributes to detect any anomalous events. Anomalous events are classified as anomalous including the identifier for code or AI model used to determine anomaly. The “Enrichment” part of the event appended by the application server 102 includes the following:
(a) Enrichments—Output of various AI models, code and anomaly detection patterns,
(b) Accelerators—Output of various data preparation routines including vectorized version of the event attributes, text prepared for NLP and any other data transformation required for downstream data science,
(c) Performance—Performance data for AI model and code execution on the event including time taken, CPU utilization, memory utilization, network utilization,
(d) Labels—Output of any manual labels applied to the event, and
(e) Privacy Check—Output of analysis designed to detect private or IP related information in the event.

In an embodiment, the application server 102 may further dynamically scale up or down the copies of AI models or copies of the codes as needed to scale up/down to the incoming events of each event category. The application server 102 may further use predictions of incoming events across multiple event categories to scale up or down the number of AI model copies and codes needed to service the events. The application server 102 may further extract entity profile attributes from incoming events as configured in the profiler component that defines codes and configuration to be executed to extract and populate entity profile attributes from incoming events.

In an embodiment, the application server 102 may further predict the entity profile behavior using the generated profiles by applying default or custom AI models and codes. The application server 102 offers ability for external services and components to use the system as a predictive event bus i.e., use prediction based messages to send and receive predictions and signals to each other. The application server 102 has also the ability to trigger transitions in configured state machines. The application server 102 has also the ability to convert the unstructured data into AI models automatically and operationalize these models into a real-time runtime automatically. The application server 102 may be able to look at the incoming data, identify the attributes containing the unstructured data, apply a machine learning algorithm and generate the AI models that predict any or all other attributes in the data set. The application server 102 is then able to upload and operationalize one or all of the generated AI models in the runtime to apply these AI models to any new data that arrives as input.

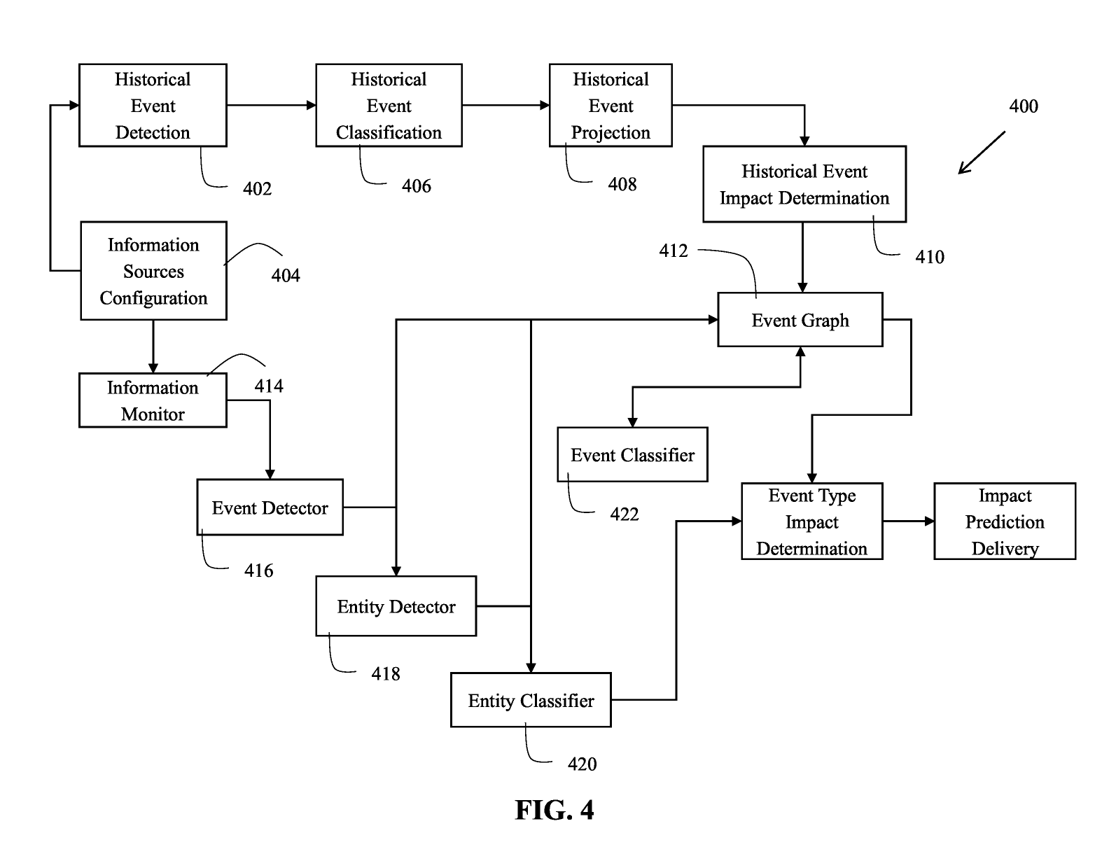

FIG. 4 shows an exemplary block diagram 400 for illustrating a technique for prediction of events to entities through generation of an impact measure between events and entities, in accordance with an embodiment of the present invention. This technique describes the event impact determination and notification system that is able to detect various types of events through monitoring of multiple information channels and predict the impact of the event on any entity and produce a list of recommended actions and highlights previous instances of similar events for similar entities and how those events impacted the entity and the actions taken by the entity to deal with the event.

In an embodiment, the historical event detection component 402 uses the configured list of information sources in the information sources configuration 404 to read all news and information across all sources stored in various storage systems such as the database server 104. The historical event classification component 406 uses various heuristics and identified patterns to classify the detected events by category. This component 406 uses machine learning drive classification and clustering algorithms to classify events into categories and types. The historical event projection component 408 uses the output of the historical event detection component 402 to perform an analysis of the event to determine the impact of that event. This component 408 performs a before and after analysis of key conditions that preceded the event and the state of these key conditions after the event across variable time windows. The component 408 determines, based on the type of the event, the key metrics and KPIs across all relevant domains and utilizes them to build a definition of the before and after state.

Further, the historical event impact determination component 410 aggregates the before and after state conditions analysis for all events of the same type or similar types and belonging to the same or similar categories. This aggregation leads to a prediction of the impact of an event of a certain type on various types of entities as determined by the relevant set of metrics and KPIs. The output of this historical analysis is stored in the event graph 412 with events and event types grouped together by the similarity of impact i.e., their similar impact on key KPIs and metrics. The events and the event types are also grouped together by the entities and the types of entities that are equally or similarly impacted by the events. The real-time information monitor 414 constantly scans all configured news and information sources and tracks all information and provides it to downstream systems. The real-time event detector 416 performs looks for the presence of events in the new information that match any of the event definitions in the events graphs. This component 416 determines whether a previously known event or an unknown event is currently occurring. Further, the entity detector 418 detects all entities that are expected to be impacted by the detected events.

Further, the entity classifier 420 determines the types and categories of entities that are expected to be impacted by the event using the previously trained and built classifier technique in the historical analysis. The event classifier 422 classifies the type of event into a category and type using the previously trained and built classifier technique in the historical analysis. Further, the event, the set of entities expected to be impacted by the event, the category and type of the event and the category and type of the entities expected to be impacted by the event are processed to generate the expected impact of the event using the classified and graph built in the historical analysis phase. The expected impact is generated by looking at the historical impact of all events (same event or of the same type) to all types of entities as an aggregate. The generated impact report and the set of relevant entities and historical events are sorted by the relevant entities that need to be notified due to the significance of the impact on those entities. This component determines the entity type, event type, expected impact as the set of KPIs and metrics expected to change significantly and the set of past events that are similar (because they impacted other similar entities or because these are events of a similar type) as historical proof and delivers the analysis in very near real time, as soon as possible to all the impacted entities over several channels.

Various components (such as the historical event detection component 402, the information sources configuration 404, the historical event classification component 406, the historical event projection component 408, the historical event impact determination component 410, the event graph 412, the real-time information monitor 414, the real-time event detector 416, the entity detector 418, the entity classifier 420, and the event classifier 422) as described here with reference to FIG. 4 may be realized or implemented using one or more processors that are included in the application server 102.

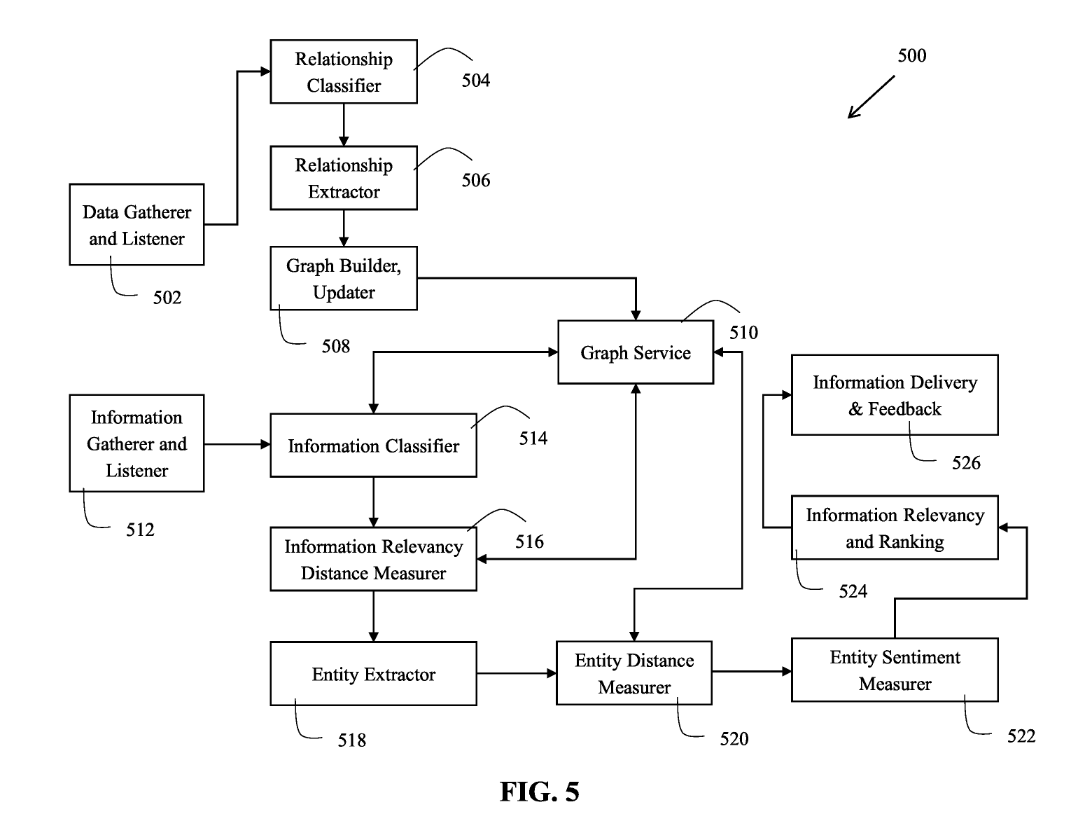

FIG. 5 shows an exemplary block diagram 500 for illustrating relevant news and information recommendations to entities, in accordance with an embodiment of the present invention. With reference to FIG. 5, a technique has been described that collects data and information from multiple sources and processes it to produce a multi relationship type graph of relationships between entities of various types. Information is gathered from many different information sources and its relevance is determined to all entities and all relevant information is then delivered to the entity and their related entities.

In an embodiment, the data gatherer component 502 systematically accesses, reads and downloads information from multiple sources in preparation for the generation of the relationship graph. The relationship classifier 504 analyzes the information (text, audio, video, images, binary, objects and other formats) and determines the type of relationship that could be extracted from the data. The types of relationships may vary and may be enhanced. For example, the types of relationships may correspond to, but are not limited to, similar location, similar time, presence in similar media, physical world relationship, user, investor, or the like. The relationship extractor 506 uses the output of the relationship classifier 504 and extracts the relevant relationships and the related entities. If an entity has not been previously observed, it is added to the graph. If a relationship type has not been previously observed, a new graph type is created.

The graph builder and updater component 508 utilizes the output of the relationship extractor 506 and generates new or updates existing relationship graphs to capture all observed relationships and entities. The graph service 510 houses the various graphs and the associated entity information and it exposes capabilities for reading/writing/updating the various graphs. The information gatherer and listener 512 scans and reads or tracks several information sources for all information. When new information is detected, it is marked for processing. The information classifier 514 uses the output of the information gatherer and listener 512 and classifies all information by sentiment (such as positive, negative, neutral, or unknown sentiment), or by impact (such as macro, micro, or industry segment). The information relevancy distance measurer 516 determines the interest that an entity would have in a particular information. This component 516 looks at the topics, entities, keywords and sentiment extracted from the information to determine the interest. This component 516 uses every entities' past behavior to determine if they would be interested in the mentioned topics, categories, entities, keywords and sentiment. In addition, the component 516 uses the past behavior of entities to determine their intent and matches the predicted intent of the entity with the information's ability to aid in the completion of the intent. This is determined through historical analysis that determines the most relevant information by measuring how often information of a certain category, topic, entity, keyword is utilized to aid in the completion of a certain intent. Further, the entity extractor 518 extracts all mentioned entities from the information.

Further, the entity distance measurer 520 determines, by using the relationship graph, to determine all the relationships and the length of these relationships between one or more entities. The component sorts the relationships found according to the relationship type and the distance between the entities. Further, the entity sentiment measurer 522 utilizes the relationship graphs to determine if there is any transfer of sentiment possible given the type of relationship and the distance between the entities i.e., does the sentiment of the news and information impact the sentiment of any entity given its distance from the entities mentioned in or discussed or referenced directly or indirectly in the news/information. The entity sentiment measurer 522 uses the relationship distance to determine and if a significant sentiment transfer is found to occur, identifies the news and information as relevant to the entity.

Further, the information relevancy and ranking component 524 utilizes the output of the entity distance measurer 520 and the entity sentiment measurer 522 to determine the list of all relevant news information for every entity in the system (based on the proximity and similarity measure across multiple relationship types). It then uses this list and sorts it by relevance (based on the proximity and similarity measure across multiple relationship types) and returns the output for delivery to the entity. The information delivery and feedback component 526 uses the output of the information relevancy and ranking component 524 to deliver the relevant news to the entity. This component 526 also collects feedback from the entity on whether they found the news and information relevant (either explicitly stated or through implicit behavior tracking e.g., did the user read the information, or did the user export the information or share the information). In addition, this component 526 also analyzes the behavior of the entity as it consumes other news and information that haven't been recommended for them and uses that to add new relationships and relationship types in the entity's relationship graph to ensure that the system can improve in its understanding of the entities' intent, interests and information needs.

Various components (such as the data gatherer component 502, the relationship classifier 504, the relationship extractor 506, the graph builder and updater component 508, the graph service 510, the information gatherer and listener 512, the information classifier 514, the information relevancy distance measurer 516, the entity extractor 518, the entity distance measurer 520, the entity sentiment measurer 522, the information relevancy and ranking component 524, and the information delivery and feedback component 526) as described here with reference to FIG. 5 may be realized or implemented using one or more processors that are included in the application server 102.

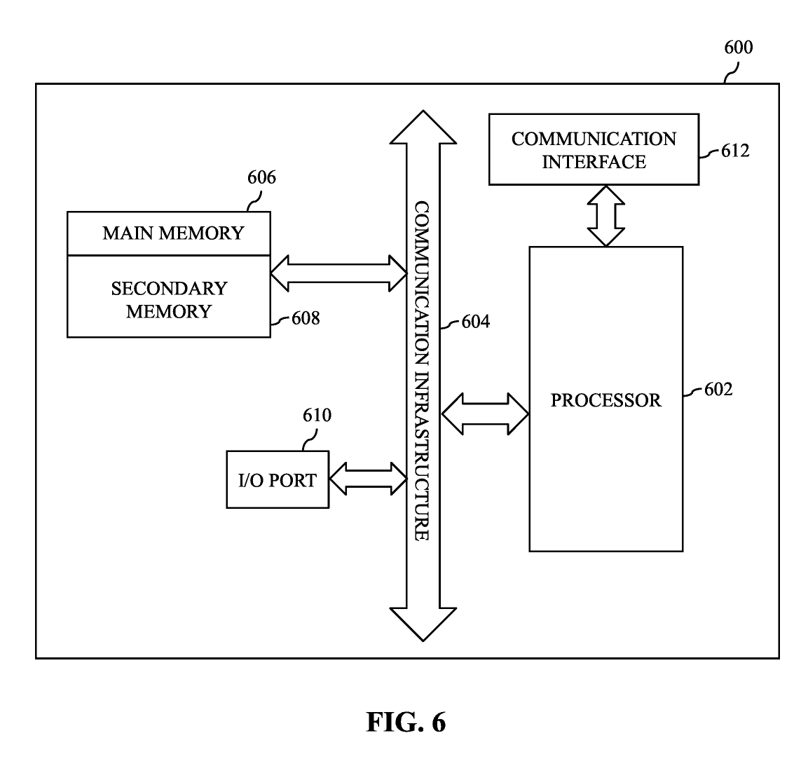

FIG. 6 is a block diagram that illustrates a system architecture of a computer system 600 for illustrating auto learning, artificial intelligence (AI) applications development, and execution, in accordance with an embodiment of the present invention.

An embodiment of the present invention, or portions thereof, may be implemented as computer readable code on the computer system 600. In one example, the application server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 2-5. The computer system 600 includes a processor 602 that may be a special purpose or a general-purpose processing device. The processor 602 may be a single processor, multiple processors, or combinations thereof. The processor 602 may have one or more processor “cores.” Further, the processor 602 may be connected to a communication infrastructure 604, such as a bus, a bridge, a message queue, the network 106, multi-core message-passing scheme, and the like. The computer system 600 further includes a main memory 606 and a secondary memory 608. Examples of the main memory 606 may include RAM, ROM, and the like. The secondary memory 608 may include a hard disk drive or a removable storage drive (not shown), such as a floppy disk drive, a magnetic tape drive, a compact disk, an optical disk drive, a flash memory, and the like. Further, the removable storage drive may read from and/or write to a removable storage device in a manner known in the art. In an embodiment, the removable storage unit may be a non-transitory computer readable recording media. The computer system 600 further includes an input/output (I/O) port 610 and a communication interface 612. The I/O port 610 includes various input and output devices that are configured to communicate with the processor 602. Examples of the input devices may include a keyboard, a mouse, a joystick, a touchscreen, a microphone, and the like. Examples of the output devices may include a display screen, a speaker, headphones, and the like. The communication interface 612 may be configured to allow data to be transferred between the computer system 600 and various devices that are communicatively coupled to the computer system 600. Examples of the communication interface 612 may include a modem, a network interface, i.e., an Ethernet card, a communications port, and the like. Data transferred via the communication interface 612 may be signals, such as electronic, electromagnetic, optical, or other signals as will be apparent to a person skilled in the art. The signals may travel via a communications channel, such as the network 106, which may be configured to transmit the signals to the various devices that are communicatively coupled to the computer system 600. Examples of the communication channel may include, but not limited to, cable, fiber optics, a phone line, a cellular phone link, a radio frequency link, a wireless link, and the like. Computer program medium and computer usable medium may refer to memories, such as the main memory 606 and the secondary memory 608, which may be a semiconductor memory such as dynamic RAMs. These computer program mediums may provide data that enables the computer system 600 to implement the methods illustrated in FIGS. 2-5. In an embodiment, the present invention is implemented using a computer implemented application. The computer implemented application may be stored in a computer program product and loaded into the computer system 600 using the removable storage drive or the hard disk drive in the secondary memory 608, the I/O port 610, or the communication interface 612.

The computer system 600, as described in the present invention, facilitates real-time, automatically scalable AI inference system for custom, training environment-agnostic AI models for performance monitoring, and fault, quality and performance remediation through prediction of failures or suboptimal performance. With the implantation of the present invention, the computer system 600 ensure privacy and secure AI training and inference mechanism for data and AI model sharing between untrusted parties and user search driven automated AI model training and operationalization. The current platform of the present invention also facilitates the ability to build auto learning applications that automatically learn and improve. The computer system will enable the determination of the impact of any event on any type of entities. The technique enables entities to be notified and prepared to react to events and their associated impact on the entity. The present invention with further enable collaborative authoring, negotiation and approval of contracts between two or parties with controlled visibility, voting and approval. Further, the proposed implementation will automatically extract contracted services description, service quality measures, service level agreements, policies, deadlines, regulatory requirements and timelines and stores and executes them automatically to ensure full compliance, measured service quality, billing implications and notifications. Further, the proposed system, technique and process of the present invention will enable the automatic generation of the best quality artificial intelligence trained models in a constantly improving, artificially intelligent driven training mechanism. In addition, the proposed technique also enables the maximum utilization of capacity of the training environment to ensure that the best models can be trained and identified.

Application and Advantages:

Most organizations will be obsolete in the age of Artificial Intelligence (AI). Advantages in the AI age will come from the assimilation of AI in every operation, decision, and action that organizations undertake. Because, existing software cannot be retrofit with AI, organizations will need to reengineer and/or rehost legacy software while rapidly experimenting with and building new applications that work across more diverse data, in real-time and impact decisions, actions, workflows and operations in real-time. At the same time, applications will need to be designed to directly, automatically, and autonomously leverage the usage of these application to make the AI in these applications and the applications themselves more accurate, efficient and valuable.

Building such AI-driven, real-time intelligent applications and systems requires an approach that is currently not possible with products and technologies available in the market. Intelligent applications are defined as
Real-time AI Inference: Applications that process multiple, disparate streams of events in real-time with multiple AI models, multiple custom business logic and multiple rules sets.
Real-time Actions: Applications that are able to leverage predictive signals in real-time to act including triggering workflows, automation, signaling, messaging and deliver notifications.
Real-time, Auto Learning Deep Analysis: Applications that are able to enable real-time analysis and support instant feedback loops and annotations to auto learn and improve as they are used.

Three key characteristics of an “intelligent, AI-driven” organization are
Ability to operationalize AI rapidly, at-scale, elastic, and across multiple applications.
Ability to build, deploy, operate, and automatically enhance real-time AI applications.
Ability to enrich historical events, classify current events, and forecast future events.

However, building intelligent applications is severely inhibited by multiple problems
Most organizations lack customizable real-time, AI-inference processing platforms.
Most data in organizations is not AI-ready and thus cannot be easily converted into

AI models.
Most organizations do not have enough data-science expertise to tackle the entire breadth of problems and modernization required.
Most organizations do not have on-demand compute available for their developers and data scientists.
Most organizations do not have a production-parallel system that enables truly scientifically accurate experimentation.

Various methods and systems may enable organizations to rapidly innovate, experiment, and deploy AI driven real-time, auto-learning custom applications with customizable, matrixed AI models, or pre-built applications powered by the AI model library disclosed in the present invention.

The realization and implementation of the present invention is designed to
Reduce time to market for AI R&D output.
Reduce time to market and data science cost required to build AI Applications.
Reduce time and cost of deploying and operating auto-scaling, elastic, high-quality AI Applications.
Reduce time and cost of modernization of legacy software.
Reduce complexity and cost of improving and enhancing AI applications.

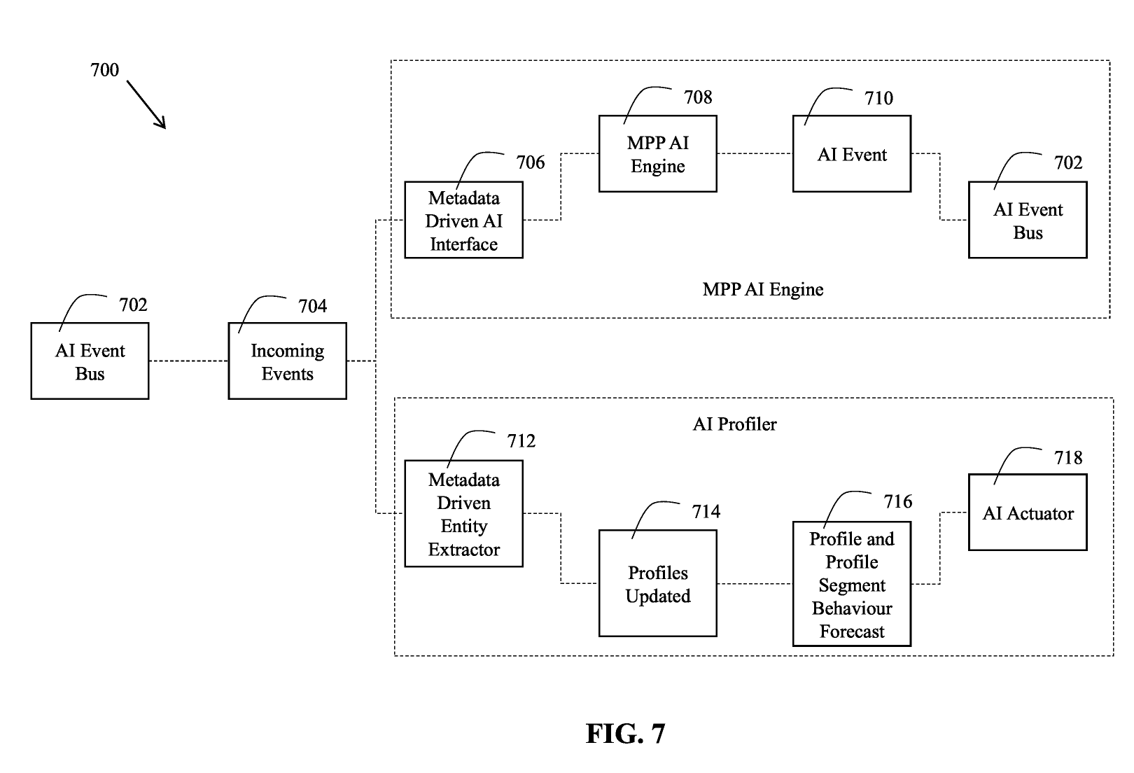

FIG. 7 is a block diagram that illustrates an exemplary architecture 700 for illustrating auto learning, artificial intelligence (AI) applications development, and execution, in accordance with an embodiment of the present invention. The exemplary architecture 700 may be realized and implemented by means of the application server 102 and/or the computer system 600. The exemplary architecture 700 shows an AI event bus 702, an incoming events terminal 704, a metadata driven AI interface 706, an MPP AI engine 708, an AI event terminal 710, a metadata driven entity extractor 712, a profiles updated terminal 714, a profile and profile segment behavior terminal 716, and an AI actuator 718. Various operations and applications of the AI event bus 702, the incoming events terminal 704, the metadata driven AI interface 706, the MPP AI engine 708, the AI event terminal 710, the metadata driven entity extractor 712, the profiles updated terminal 714, the profile and profile segment behavior terminal 716, and the AI actuator 718 haven been described below.

Technology and Architecture:

The present invention offers a real-time AI operationalization platform that enables rapid deployment and operationalization of the AI models to power real world applications through the LearnCloud platform that is available as both onprem and hosted software.

The LearnCloud platform offers comprehensive AI operationalization that is currently unavailable in the market. The following key technologies power LearnCloud platform:

1. AI Event Bus with Intelligent Enrichment Services

2. Massively Parallel Processing (MPP) AI Engine

3. Bring Your Own Models (BYOM) and AI Model Library

4. AI Profiler

5. AI Actuator

6. AutoLearner with Bias Detection and Secure Lineage

7. AI Application Performance Monitoring

8. Offline Analyst Activity

9. AI App Development and AI App Store

AI Event Bus

The AI event bus is a real-time event processing, messaging, and signaling event bus that generates and delivers AI predictions to various applications enabling multiple applications to communicate with each other and leverage predictions to drive application processing. The AI event bus has access to Intelligent Enrichment Services that classify, annotate, detect, secure, decorate, enhance, and secure incoming events and append a uniformly generated “semantic” layer across all disparate events enabling these events to be connected and correlated.

Massively Parallel Processing (MPP) AI Engine

The MPP AI engine has the ability to operationalize a M×N matrix of AI models, where M is the number of unique AI models and N is the number of duplicate copies of each AI model. The MPP AI engine has the ability to scale up or down the number of copies of each AI model depending on the expected/predicted incoming event traffic volume. The MPP AI engine leverages AI to optimize itself.

Bring Your Own Models (BYOM)

LearnCloud's BYOM acknowledges the following and delivers a functionality set that complex organizations like the Air Force require to maintain superiority in a world powered by AI.
AI is not one size fits all i.e., it needs to be customized to the problem, the operating environment and the specific users interacting with the application.
AI is not static i.e., it needs to be constantly improve and adapt to its operating environment, users and state of the problem.
AI is not singular i.e., multiple AI models built using a multitude of techniques should be leveraged together to drive the best AI predictions.
AI is not isolated i.e., it needs to be intrinsically embedded in a solution workflow to deliver the broadest and deepest impact.
AI should auto learn i.e., in an operating environment like the Air Force where the number of AI models is expected to be in the 10s of thousands, AI models cannot be subject to manual training and maintenance. AI at this scale and complexity needs to automatically learn, improve, and adjust.
   BYOM separates the training of AI models from the operationalization of AI models enabling a diversity of AI models trained in different environments, by diverse in-house or contracting teams, with different assumptions to be operationalized in the same real-time AI processing environment. BYOM frees organizations to parallelize AI training and AI operationalization for faster time to market and ROI from AI investments. At the same time, LearnCloud offers a pre-built library of AI models (40+) across several use cases for usage as needed.

AI Profiler

LearnCloud's AI profiler enables the profiling of entities through the definition, generation, and maintenance of individual profiles of any type of entities such as users, devices, machines, equipment, applications, systems, and processes. The AI profiler uses the custom definitions of entity profile and the custom defined entity-profile processors to extract attributes from incoming events and update the associated profiles. The profiles are then analyzed in real-time individually or segmented to compare current behavior against expected behavior to generate an action plan that is executed in real-time.

AI Actuator

LearnCloud's AI Actuator offers a comprehensive library of action capabilities such as API execution, alerting, notification, new event generation, workflow triggers, or the like. Custom actuator configurations determine the one or more actions to be executed in real-time based on the generated predictions.

AutoLearner

LearnCloud's AutoLearner leverages the usage of an application by users or the behavior of the users in the context of an application or the search/analytical activity of users on the application's data to automatically generate input data frames, labels for each row in the data frame, and converts the data frame into AI models that can predict the label. AutoLearner uses proprietary AutoML implementations to automatically train an AI model and optimize it using a grid search algorithm. These AI models are automatically operationalized through the BYOM component's APIs. The AutoLearner also provides Bias Detection by automatically analyzing the distribution of labels and the labeler user profiles to generate a probability of bias in the input data set and the resulting AI model. The AutoLearner also has the ability to operate on encrypted raw data and also store the trained models in an encrypted manner and track/audit each AI model inference to offer transparency and trustworthy AI.

AI Application Performance Monitoring (APM)

LearnCloud's AI App APM offers application performance monitoring for AI applications. Operationalization of AI applications needs to measure and optimize the performance of the one or more AI models embedded in the application. This requires the collection of data that provides monitoring overview of the AI models including time to execute inference and success/failure of AI inference for each AI model. The AI App APM automatically collects data to enable AI App APM.

Offline Analyst Activity

LearnCloud's Offline Analyst Activity capability enables analysts to perform several functions on the raw events or the predictions on those events including:
Development of Information APIs
Development of Analytics APIs
Development of Information Bots
Development of Analytics and Dashboards
Search capability across events and predictions
Design of Data Frames for AI training
Portals for Digital Asset Sharing across organizations
Development of AI including Topic Modeling, Keyword Extraction, Entity Recognition, Forecasts, Spike Detection, Clustering, Anomaly Detection, Classifiers

AI App Development and AI App Store

LearnCloud's AI App Development capability enables developers, data scientists and analysts to rapidly build and deploy real-time AI applications through its AI App Builder workflow. The AI App Builder Workflow offers a guided, step-by-step, flexible workflow to build comprehensive AI apps, deploy them into the runtime and publish into the AI App Store for easy consumption by consumers. The AI App Development functionality includes the following capabilities
Input Event Category Design
Pre-built AI Models selection across NLP, Anomaly Detection and domain specific AI
BYOM—Custom AI Upload and Operationalization using AI models trained anywhere
BYOM—Custom Event Enrichment and Transformations using uploaded python logic
AI Profiling—Custom Entity, Profile and Profile Processing to drive profile behavior predictions
Routers—Custom Event Prediction driven Actions such as API call, Notifications, or the like.
Notifications—Custom Event Prediction driven Alerts and Notifications
Offline Analyst Activity Development (see above)
AI App APM to drive quality operations of AI apps

Deployment and Activation

The AI platform of the present invention has been designed to create a new Intelligent and Uniform Information Plane for organizations to leverage AI at scale in a diverse set of new AI applications or AI plugins for existing, legacy applications.

An operating environment of the present invention enables experimentation, iterative prototyping, and operationalization of AI applications through a production-parallel setup that massively cuts down the cost of building and deploying AI applications, thereby enabling innovation and agility. In addition, the LearnCloud platform essentially offers on-demand compute and acts as a data and services abstraction layer for the organizations. This enables the organization to rapidly build new applications that actually impact current processes and workflows speeding up and increasing ROI from technology investments. The Intelligent and Uniform Information Plane busts data silos across the organizations and enriches all data using the same set of AI models, thus uncovering connections and relationships that otherwise are not obvious. Any and all apps built on this platform are automatically interconnected and the behavior/usage by users on one application can be used to inform and enhance the behavior of other applications.

The LearnCloud platform enables auto learning applications that are able to establish feedback looks and actions. These actions are tracked and automatically used to improve the AI behind the applications essentially reducing the need for data science team sizes to scale linearly with the number of AI applications. The LearnCloud platform further enables analysts and semi-technical users in the organizations to experiment with and build AI applications, thereby increasing the available data science bandwidth in the organizations. The LearnCloud platform is available both as a hosted application on a cloud server (such as the application server 102) or as a hosted service on the organization's private cloud or as an on-premises deployment.

Although particular embodiments of the invention have been described in detail for purposes of illustration, various modifications and enhancements may be made without departing from the spirit and scope of the invention.

What is claimed is:

1. An artificial intelligence (AI) inference system, comprising:
circuitry configured to facilitate:
real-time, automatically horizontally scalable AI inference for custom, training environment-agnostic AI models;
automated AI application performance monitoring, and fault, quality and performance remediation through prediction of failures or suboptimal performance;
privacy and secure AI training and inference mechanism for data and AI model sharing between untrusted parties; and
ability to build auto learning applications that automatically learn and improve.

2. The AI inference system of claim 1, further comprising a user platform that facilitates a user to perform operations comprising:
building an abstraction layer for data and services through a proprietary standardized header format;
generating new events by combining multiple events using time, location or any other attributes with a considerable overlap and processing these combinations with business logic;
selecting one or more AI models available in an AI model library;
uploading and configuring one or more custom business logics for event processing as logic that is executed when a new event arrives; and
uploading and configuring one or more custom AI models to be executed when events belonging to a certain event category arrive.

3. The AI inference system of claim 2, wherein the circuitry is configured to append an output of one or more default AI models, custom AI models, and custom business logics on to the event to extend and enrich the event.

4. The AI inference system of claim 3, wherein the circuitry is configured to stamp performance measures of the execution of the one or more AI models on events including success or failure, time taken, and memory consumed on to the original event for each AI model.

5. The AI inference system of claim 2, wherein the user platform further facilitates the user to perform operations comprising:
configuring entity definitions as a set of attributes that define an entity, wherein the entity is a person, a place, or a thing;
uploading and configuring one or more entity event processors that extract attribute values and information from the events and update and build entity profiles; and
configuring data frames that convert incoming events into processed, transformed, and enriched dataset definitions including AI-readiness enrichments through application of automated signal detection, automated feature engineering and automated information content estimation.

6. The AI inference system of claim 1, wherein the applications are automatically configured with ticketing capability to automatically and instantly record and process all user interaction with an event to feed directly into new AI model training to produced better event enrichment.

7. The AI inference system of claim 1, wherein the applications are automatically interconnected and able to communicate with each other by sending and receiving predictive messages over an AI event bus.

8. The AI inference system of claim 3, wherein the circuitry is configured to create an AI model matrix based on number of unique AI models and number of replicas of each AI model, wherein the one or more default AI models and custom AI models are supported by the matrix.

9. The AI inference system of claim 3, wherein the circuitry is configured to create an AI model based on number of custom business logics and number of replicas of each custom business logic, wherein the one or more default business logic and custom business logic are supported by the matrix.

10. The AI inference system of claim 1, wherein the circuitry is configured to automatically detect a presence of available GPU resources, a presence of suitable business logics or AI models, and an availability of the GPU resources.

11. The AI inference system of claim 10, wherein the circuitry is further configured to automatically configure processing to leverage GPUs to ensure all event processing can leverage GPU capabilities as needed.

12. The AI inference system of claim 11, wherein the circuitry is further configured to automatically and instantly update profile attributes of any and all entities as configured and detected in incoming events.

13. The AI inference system of claim 12, wherein the circuitry is further configured to use the updated profile attributes to predict and forecast behavior of any of entities.

14. The AI inference system of claim 13, wherein the circuitry is further configured to automatically segment and/or cluster entity profiles based on their specific attributes and attribute combinations.

15. The AI inference system of claim 14, wherein the circuitry is further configured to automatically determine a set of AI models to be applied to any incoming event by inspecting the event's structure, attributes, attribute values, source, payload details and other metadata.
